(19) United States
(12) Patent Application Publication
(10) Pub. No.: US 2017/0075555 A1
(43) Pub. Date: Mar. 16, 2017

(54) DYNAMICALLY DISPLAYING INFORMATIONAL CONTENT ON A CONTROLLER DISPLAY

(71) Applicant: EMERSON ELECTRIC CO., St. Louis, MO (US)

(72) Inventor: Zhongliang Xu, Xi'an (CN)

(21) Appl. No.: 15/261,018

(22) Filed: Sep. 9, 2016

(30) Foreign Application Priority Data
Sep. 11, 2015 (CN) 201510580381.X

(51) Int. Cl. G06F 3/0484; F24F 11/00; G05B 19/042; G06F 3/01; G05B 19/409

(52) U.S. Cl. CPC G06F 3/04847; G06F 3/011; G06F 3/017; G05B 19/409; G05B 19/0428; F24F 11/0086; F24F 11/006; F24F 11/0034; F24F 2011/0091; F24F 2011/0061; F24F 2011/0035

(57) ABSTRACT

Disclosed are exemplary embodiments of systems and methods for dynamically displaying informational content on a controller display. In an exemplary embodiment, a climate control system controller generally includes a display and at least one sensor configured to detect a user within a vicinity of the climate control system controller. A distance is determined between the climate control system controller and the detected user. Based on the determined distance, a first or a second display component arrangement is shown on the display. Informational content of the second display component arrangement differs at least in part from informational content of the first display component arrangement.

### CROSS-REFERENCE TO RELATED APPLICATION

This application claims the benefit and priority of Chinese Patent of Invention Application No. 201510580381.X filed Sep. 11, 2015. The entire disclosure of the above application is incorporated herein by reference.

### FIELD

The present disclosure generally relates to dynamically displaying informational content on a controller display.

### BACKGROUND

This section provides background information related to the present disclosure which is not necessarily prior art.

Thermostats for climate control systems typically include a display on which informational content such as temperature, settings, etc. may be shown to users of the climate control system.

### SUMMARY

In thermostats that have display screens, information typically is displayed so as to be legible by a user who is close to the thermostat. If the user is farther away from the thermostat, however, the user can find it difficult to read the information shown on the display. It can be especially difficult if not impossible for someone at a distance from a thermostat to read any particular item of information on a thermostat display that shows a plurality of items of information. Thermostat displays typically show information in static and complicated ways, e.g., in character fonts too small to be read except by a user close to the display. In various embodiments, the present disclosure is directed to solving such technical problems.

According to one example embodiment of the disclosure, a climate control system controller comprises:

a display;

at least one sensor configured to detect a user within a vicinity of the climate control system controller; and

a processor configured with the sensor to determine a distance between the climate control system controller and the detected user, the processor further configured to show on the display, based on the determined distance, a first or a second display component arrangement;

wherein informational content of the second display component arrangement differs at least in part from informational content of the first display component arrangement.

According to another example embodiment of the disclosure, a climate control system controller-performed method of displaying information comprises:

detecting a user within a vicinity of the climate control system controller, the detecting performed by a sensor;

determining a distance between the detected user and the climate control system controller;

based on the determined distance, displaying informational content in a display component arrangement on the display; and

when the determined distance changes, changing the displayed informational content at least in part.

According to another example embodiment of the disclosure, a thermostat comprises:

a display; and

at least one sensor and a processor configured to detect a user within a vicinity of the thermostat and determine a distance of the user from the thermostat based on the detecting;

the processor further configured to, based on the determined distance, change informational content of a display component arrangement for the display.

In various embodiments of the disclosure, the following technical effects can be achieved. It can be convenient for a user who is at a distance from a thermostat to read at least one item of information on the thermostat display, without having to move closer to the thermostat. Many users who have advanced age and/or who have imperfect eyesight can find it easier to read information that is shown, e.g., in a large character font on a thermostat display. User experience is improved, where a user at a distance from a thermostat can read at least one item of information such as the current temperature on the thermostat display, and can read other or additional information as the user moves closer to the thermostat display.

### DRAWINGS

The drawings described herein are for illustrative purposes only of selected embodiments and not all possible implementations, and are not intended to limit the scope of the present disclosure.

FIG. 1 is a diagram of a structure including a climate control system and controller in accordance with an example embodiment;

FIG. 2 is an illustration of a thermostat in accordance with an example embodiment;

FIG. 3 is a diagram illustrating changing distances between a user and a thermostat and changing displays based on the distances in accordance with an example embodiment; and

FIG. 4 is a flow diagram of a method of dynamically displaying content on a controller display in accordance with an example embodiment.

Corresponding reference numerals indicate corresponding parts throughout the several views of the drawings.

### DETAILED DESCRIPTION

Example embodiments will now be described more fully with reference to the accompanying drawings.

The inventors hereof have recognized that displays of temperature, humidity, etc. on a thermostat can be difficult for a user to read who is not close to the thermostat. Thermostat display information often is presented in a small, fixed font that can be illegible at a distance from the thermostat.

Accordingly, the inventors have developed and disclose herein exemplary embodiments of a climate control system controller, e.g., a thermostat, having a display. In various embodiments, the informational content of what may be displayed on the display is changed as a function of distance of a user from the display. The distance is determined, e.g., by a processor of the controller using input from a sensor. In one example embodiment, a thermostat processor is configured to display a first display component arrangement or a second display component arrangement on a display, based on a distance determined between the thermostat and a user. In one example embodiment, informational content of the second display component arrangement differs at least in part from informational content of the first display component arrangement. It should be noted generally that although various embodiments are discussed herein with reference to thermostats, the disclosure is not so limited. Embodiments are possible in which other types of controllers having user interfaces may embody various aspects of the disclosure.

Unless otherwise indicated herein, the term “informational content” is used to refer to substantive information provided on a display in one or more display components. Unless otherwise indicated herein, the term “display component” is used to refer to an arrangement of pixels, etc. used to convey informational content on a display. Thus a display component may be characterized by size, color, pixel density, shape, font, font size, etc. Informational content may be or include, e.g., time, temperature, humidity, control settings, etc. and may be set forth in one or more display components.

In some example embodiments, a thermostat display shows nothing until a user moves to within a first predefined distance from the thermostat. When the user has moved to within the first distance, the display shows one or more first display components. In one example embodiment, the first display component(s) may provide a single item of informational content, e.g., current ambient temperature sensed by the thermostat. The informational content may be displayed in the first display component(s), e.g., in large font(s) preselected, e.g., as being legible by the user from the first distance. In some other embodiments, other or additional items of informational content could be shown.

When the user has moved closer to the thermostat, e.g., to within a second predefined distance shorter than the first distance from the thermostat, the display shows one or more second display components. In one example embodiment, the second display component(s) show items of informational content in addition to the informational content of the first display component(s). Thus, the second display component(s) may include, e.g., current sensed ambient temperature, humidity, system operating mode, etc. When the user is within the second distance from the thermostat, the second display component(s) may display informational content, e.g., in font(s) and/or size(s) smaller than the font(s) and/or size(s) used on the display when the user is within the first distance from the thermostat but not within the second distance.

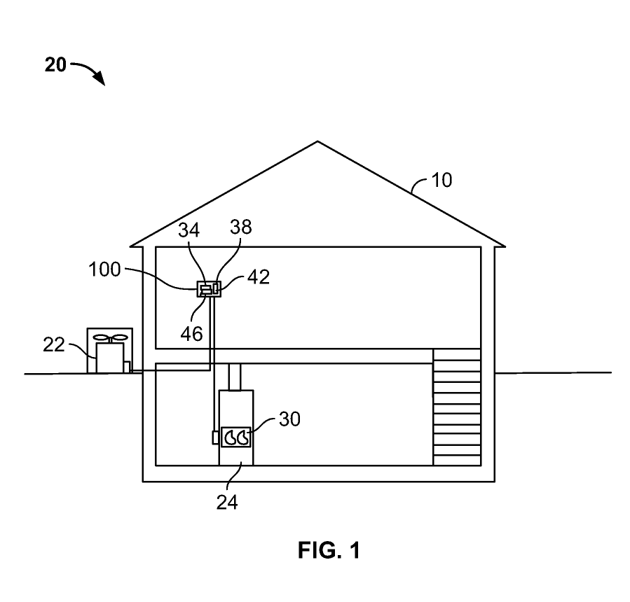

With reference now to the figures, FIG. 1 illustrates an exemplary embodiment of a structure 10 in which a climate control system controller such as a thermostat 100 is installed, the thermostat 100 embodying one or more aspects of the present disclosure. The structure 10 may be, for example, a residence, a business premises, a building or structure for commercial, farming and/or industrial use, etc. The example thermostat 100 is configured for communication with and for control of various components of an example climate control system 20. The climate control system 20 includes, e.g., an air conditioning system 22, a blower unit 24, and a heating system 30.

The thermostat 100 has a display device or display 34, a processor, e.g., a microprocessor 38, and electronic memory 42. The memory 42 may include various types of memory, e.g., random access memory (RAM), erasable programmable read-only-memory (EPROM), electronically erasable programmable read-only-memory (EEPROM), etc. The thermostat 100 further includes a temperature sensor 46 configured to sense and provide information that is indicative of ambient temperature in the structure 10. The microprocessor 38 is configured for communication with the temperature sensor 46, to obtain signal information from the sensor 46 indicative of the temperature in the structure 10. The temperature sensor 46 may be any of a number of sensor types, and may include circuitry to enable communication of temperature information on a periodic basis, or upon request, such as when prompted by the microprocessor 38. The thermostat 100 is installed and oriented in the structure 10 so as to allow a user to view information provided on the display 34.

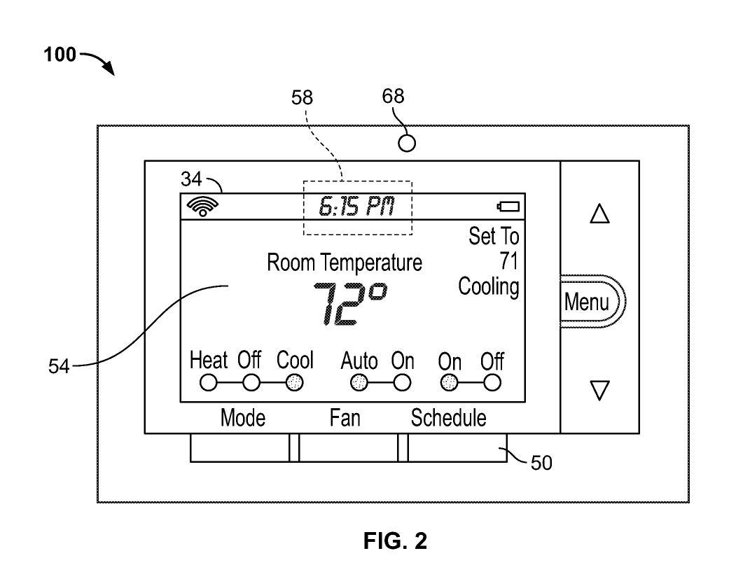

A frontal view of the thermostat 100 is shown in FIG. 2. The thermostat 100 includes user input means, e.g., buttons 50 for mode selection, fan selection, scheduling, and menu item selection. The display 34 includes a screen 54 that may be backlighted in some embodiments. The display 34 may include, e.g., a dot matrix display, a projection display, etc. In various embodiments, a display of a thermostat or other controller may include a touch screen operable, e.g., by a user touching icons on the touch screen. In the present example embodiment, various items and types of informational content are shown on the screen 54 in a plurality of display components 58. For example, current time is shown in a display component 58 that is a text component. In some other embodiments, current time could be shown in a display component that is, includes, and/or is included in an image, e.g., of a clock face, etc. It should be noted generally that a “display component” as referred to herein may be a subpart of a more inclusive “display component.” For example, a single letter of a text display component may also be referred to as a “display component.”

The thermostat 100 also includes at least one proximity sensor 68 configured with the processor 38 to detect a distance between the display 34 and a user who is within range of the sensor 68. As further described below, the processor 38 is configured to show various display components on the display 34. Which display component(s) may be displayed depends, e.g., on a detected distance between the display 34 and a user. In various embodiments, the proximity sensor 68 may be or include an infrared sensor, e.g., a pyroelectric infrared sensor from Murata Manufacturing Co., Ltd., www.murata.com. In some example embodiments, the sensor 68 may be or include gesture recognition capability available, e.g., from Texas Instruments Incorporated, www.ti.com, and/or may be configured with the processor 38 to provide motion control of what is displayed on the display 34. In some other example embodiments, an ultrasonic sensor may be used to detect a distance between the display 34 and a user. Unless otherwise indicated, the term “proximity sensor” may be used herein to refer to various types of sensors and sensing configurations for providing information useful in determining distance.

In various embodiments, proximity sensors may be operative to transmit signals in fan shapes, lobes and/or other transmission patterns in order to detect the presence of a person (or other object) within sensor range. In the present example embodiment, the microprocessor 38 is configured to receive signals from the proximity sensor 68 indicating that the sensor 68 has detected a user (or other person or object) within sensor range. The processor 38 may use the signals received from the sensor 68 to determine a distance between the sensor 68 and the detected person.

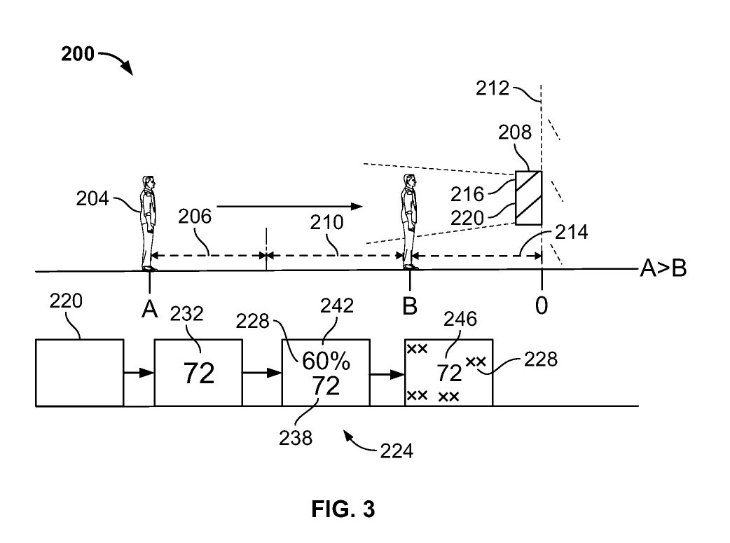

FIG. 3 illustrates an example plurality of distances 200 across which a user 204 may move, e.g., to approach an example embodiment of a thermostat 208. The thermostat 208 is mounted on a surface, e.g., a wall 212, and includes one or more proximity sensors 216. The thermostat 208 is oriented, e.g., so as to allow the user to see a thermostat display 220, and so as to allow the proximity sensor(s) 216 to detect the presence of the user 204 as the user 204 approaches and/or moves away from the thermostat 208. An example sequence 224 of display components 228 providing informational content may be shown on the display 220, based on the distances 200 as determined, e.g., by a processor (not shown) of the thermostat 208.

In the present example embodiment, when there is no user present in the vicinity of the thermostat 208, and/or when the user 204 is far enough away from the thermostat 208, e.g., that the user 204 is outside the range of the proximity sensor(s) 216, no display components 228 are shown on the display 220. In some other embodiments, however, the display 220 could show at least some information even when no user is detected within sensor range. Embodiments are also possible in which no display components are shown when a user is detected within sensor range but is determined by the processor to be too far away from the display 220 to be able to read it.

As the user 204 moves toward the thermostat 208 and is determined by the processor to be at or within a distance “A” from the thermostat 208, a single item of informational content, e.g., the current ambient temperature, is displayed on the display 220. In the present example embodiment, the current ambient temperature is displayed in a display component 232, e.g., a text component having a large font size for making the informational content legible from the distance “A.” The display component 232 continues to be displayed, e.g., as long as the user is detected within a region 206 that includes the distance “A”.

In the present example embodiment, as the user moves closer to the thermostat 208, the processor changes the informational content and/or display component(s) 228 on the display 220 in accordance with the current distance of the user 204 from the thermostat 208. For example, when the user 204 has moved past the region 206 and enters a region 210, the display 220 shows not only the current ambient temperature but also the current humidity. Current ambient temperature is displayed in a display component 238, e.g., a text component having a font size smaller than that of the display component 232 displayed for the distance “A.” The display component 238 font size is selected, e.g., to make the display component 238 legible by a user who is moving or has moved closer to the thermostat 208 from the region 206 but is farther, e.g., than a distance “B” from the thermostat 208. Current humidity is displayed in a display component 242, e.g., a text component having a font size small enough to fit in the display 220 with the display component 238 but determined as being large enough to be legible from the user's current distance relative to the thermostat 208.

When the user has come to within the distance “B” of the thermostat 208, the display 220 shows a plurality of informational content items, including current ambient temperature, current humidity, current temperature set-point, etc. The informational content is shown in display components 246, which in the present example embodiment are text components having font sizes small enough to allow all of the informational content to fit in the display 220. In the present example embodiment, the display components 246 and their informational content continue to be shown as the user 204 moves from the distance “B,” within a region 214 close to the thermostat 208. In some example embodiments, the same sequence 224 of display components is shown in reverse order as the user moves away from the thermostat 208. In some other embodiments, a different sequence of informational content and/or display components could be shown as a user moves away from a thermostat. It should be noted that regions in relation to which corresponding display component arrangements are displayed may vary in size, distance(s) from the thermostat 208, etc., and can be irregular in shape. In some embodiments a processor may use a region in which the user 204 is detected to determine a distance of a user from the display 220.

In some example embodiments, a user may select which informational content items to display at various distances from a thermostat. In one example embodiment, a user may choose to display the current temperature setting instead of the current ambient temperature at the distance “A.” In another example embodiment, a user may choose to display both the current temperature setting and the current ambient temperature at the distance “A,” although perhaps at a smaller font size than one used for displaying only one of the temperature values. In various embodiments, a user may access a menu of informational content items selectable for display in accordance with distance of the user from the thermostat. Such a menu may be made available, e.g., via menu buttons on the thermostat, via a user application on a mobile device, from a website accessible by an Internet-enable thermostat, etc.

Information content and/or display components may vary in various embodiments. Additionally or alternatively, the numbers of changes of display components and/or informational content could vary, as could the distances at which such changes may be made on a display. Thus, in some embodiments, a sequence of changing display components may be shown in more or fewer display screen configurations than as provided by the example sequence 224 of different display screen configurations. Embodiments are possible in which a display progressively shows display components that do not change in size, but do change in their informational content as a user moves toward or away from a thermostat or other controller. It should be noted that display components are not necessarily text components, but additionally or alternatively could include imagery. A display component could include text in more than one font, imagery, imagery and text, etc.

Embodiments also are possible in which one or more items of informational content displayed when a user is within a first distance from a thermostat may be omitted from display components displayed when the user is within a second distance. Thus, a second set of display components does not necessarily include all, or even any, informational content included in a first set of display components. In some embodiments, two sets of display components can be mutually exclusive with respect to their informational content.

In various embodiments, methods are provided for dynamically displaying informational content on a controller display. In one example implementation, a controller-performed method of displaying information includes detecting a user in a vicinity of a climate control system controller display. The detecting is performed by a processor of the controller using a sensor. A distance is determined between the detected user and the display. Based on the determined distance, informational content is displayed in one or more display components on the display. When the determined distance changes, the informational content is changed.

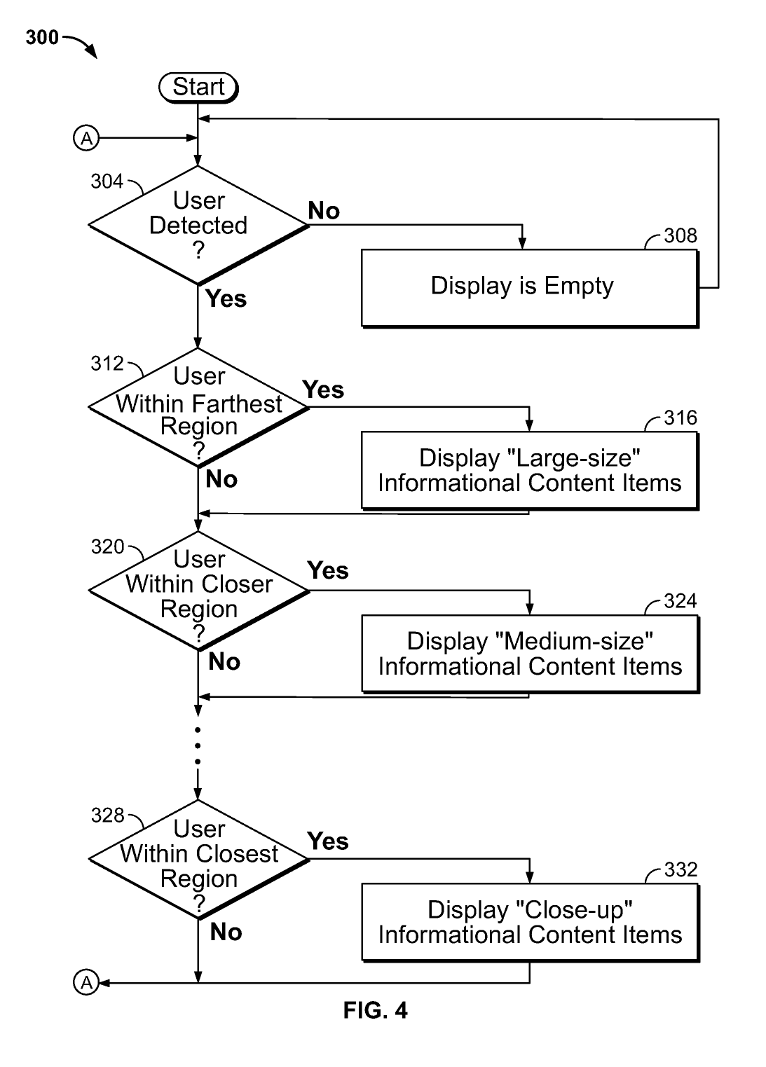

One example method of dynamically displaying informational content on a controller display is indicated generally in FIG. 4 by reference number 300. The method 300 may be performed, e.g., by a thermostat or other controller. In process 304, it is determined, e.g., by a processor of the thermostat, whether the presence of a user is detected, e.g., by a sensor of the thermostat. If no user is detected, in process 308 a display of the thermostat is not provided with any information to display. If a user is detected, it is determined in process 312 whether the user is within a region farthest from the display. If not, control passes to process 320. If yes, then in process 316 a first, e.g., a “large-size,” display component arrangement of informational content is displayed on the display. The informational content may or may not consist of a single item of informational content.

In process 320, it is determined whether the user is within a region that is closer to the display than the farthest region. If not, control passes to process 328. If yes, then in process 324 a second, e.g., a “medium-size,” display component arrangement of informational content is displayed on the display. The informational content is different at least in part from the informational content displayed in the “large-size” display component arrangement. It should be understood that additional processes could be provided, e.g., between processes 320 and 328, whereby additional display component arrangements may be displayed.

In process 328, it is determined whether the user is within a region that is closest to the display. If not, control passes to process 304. If yes, then in process 332 a third, e.g., a “close-up,” display component arrangement of informational content is displayed on the display. The informational content is different at least in part from the informational content displayed in the previously displayed display component arrangement. In some example implementations, the “close-up” display component arrangement provides the most informational content of the display component arrangements, e.g., in small type legible by a user who is close to the display.

Embodiments of the foregoing controllers and methods can provide a simple thermostat display that can be read by a user who is a distance away from the thermostat. More information is made available to the user as the user approaches the thermostat. Thus a thermostat can provide an improved user experience, in contrast to thermostats that are limited to showing a single display that typically is legible only by a user who is near the thermostat.

In accordance with aspects of the present disclosure, exemplary embodiments are disclosed of methods and apparatus for dynamically displaying informational content on a controller display. In one example embodiment, a climate control system controller includes a display, and at least one sensor configured to detect a user within a vicinity of the climate control system controller. A processor is configured with the sensor(s) to determine a distance between the climate control system controller and the detected user. The processor is further configured to use the determined distance to determine whether a showing of one of a first or a second display component arrangement on the display would be legible by the detected user, and to use the determined distance to select the first or the second display component arrangement for showing on the display, informational content of the second display component arrangement differing at least in part from informational content of the first display component arrangement. In one example embodiment, the sensor(s) include one or more of the following: an ultrasound sensor, an infrared sensor, and a sensor providing gesture recognition. In one example embodiment, the processor is configured to display one of the first and second display component arrangements based at least in part on a region in which the user is detected. In one example embodiment, the processor is configured to display either of the first and second display component arrangements based at least in part on the same region. In one example embodiment, the processor is configured to display the second display component arrangement when the determined distance is less than a minimum distance at which the first display component arrangement is displayable. In one example embodiment, a given display component of the second display component arrangement has a smaller size on the display than a corresponding display component of the first display component arrangement, the given and corresponding display components including the same informational content. In one example embodiment, the given and corresponding display components include one or more of the following: ambient temperature, temperature setting, humidity, humidity setting, time, mode, and fan setting. In one example embodiment, the controller is further configured to provide a menu of display components and informational content user-selectable therefrom for display on the display. In one example embodiment, the processor is configured to change a display size of at least one display component based on the determined distance. In one example embodiment, the controller includes a thermostat.

In one example embodiment, a climate control system controller-performed method of displaying information on a display of the controller includes detecting a user within a vicinity of the climate control system controller, the detecting performed by at least one sensor. A distance is determined between the detected user and the climate control system controller. Based on the determined distance, informational content is displayed in a display component arrangement on the display; and when the determined distance changes, the displayed informational content is changed at least in part. In some embodiments, the method includes using the determined distance to determine whether a display of the changed information content would be legible by the detected user. In some embodiments, the method is performed by a thermostat. In one example embodiment, the method further includes displaying the changed informational content in a second display component arrangement on the display. In one example embodiment, the method further includes reducing or increasing a display size of one or more display components based on the determined distance. In one example embodiment, when the determined distance is shorter than a previously determined distance, a display component arrangement is changed by reducing a display size of one or more display components and by adding one or more display components having additional informational content. In some example embodiments, determining a distance between the detected user and the climate control system controller is based at least in part on a region in which the user is detected.

In one example embodiment, a thermostat includes a display, and at least one sensor and a processor configured to detect a user within a vicinity of the thermostat and determine a distance of the user from the thermostat based on the detecting. The processor is further configured to determine whether a change of informational content of a display component arrangement on the display would be legible by the detected user at the determined distance, and based on the determining, change the informational content on the display. In one example embodiment, the thermostat is configured to change the informational content by adding and/or subtracting one or more items of informational content. Additionally or alternatively, the thermostat may be configured to change the size of one or more display components of the display component arrangement for the display.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A climate control system controller comprising:
a display;
at least one sensor configured to detect a user within a vicinity of the climate control system controller; and
a processor configured with the at least one sensor to determine a distance between the climate control system controller and the detected user, the processor further configured to:
use the determined distance to determine whether a showing of one of a first or a second display component arrangement on the display would be legible by the detected user; and
use the determined distance to select the first or the second display component arrangement for showing on the display, informational content of the second display component arrangement differing at least in part from informational content of the first display component arrangement.

2. The climate control system controller of claim 1, wherein the at least one sensor comprises one or more of the following: an ultrasound sensor, an infrared sensor, and a sensor providing gesture recognition.

3. The climate control system controller of claim 1, wherein the processor is configured to display one of the first and second display component arrangements based at least in part on a region in which the user is detected.

4. The climate control system controller of claim 3, wherein the processor is configured to display either of the first and second display component arrangements based at least in part on the same region.

5. The climate control system controller of claim 1, wherein the processor is configured to display the second display component arrangement when the determined distance is less than a minimum distance at which the first display component arrangement is displayable.

6. The climate control system controller of claim 1, wherein a given display component of the second display component arrangement has a smaller size on the display than a corresponding display component of the first display component arrangement, the given and corresponding display components including the same informational content.

7. The climate control system controller of claim 6, wherein the given and corresponding display components include one or more of the following: ambient temperature, temperature setting, humidity, humidity setting, time, mode, and fan setting.

8. The climate control system controller of claim 6, further configured to provide a menu of display components and informational content user-selectable therefrom for display on the display.

9. The climate control system controller of claim 1, wherein the processor is configured to change a display size of at least one display component based on the determined distance.

10. The climate control system controller of claim 1, comprising a thermostat.

11. A climate control system controller-performed method of displaying information on a display of the controller, the method comprising:
detecting a user within a vicinity of the climate control system controller, the detecting performed by at least one sensor;
determining a distance between the detected user and the climate control system controller;
based on the determined distance, displaying informational content in a display component arrangement on the display; and
when the determined distance changes, changing the displayed informational content at least in part.

12. The method of claim 11, further comprising using the determined distance to determine whether a display of the changed information content would be legible by the detected user.

13. The method of claim 11, further comprising displaying the changed informational content in a second display component arrangement on the display.

14. The method of claim 11, further comprising reducing or increasing a display size of one or more display components based on the determined distance.

15. The method of claim 11, further comprising:
when the determined distance is shorter than a previously determined distance, changing a display component arrangement by reducing a display size of one or more display components and by adding one or more display components having additional informational content.

16. The method of claim 11, wherein determining a distance between the detected user and the climate control system controller is based at least in part on a region in which the user is detected.

17. The method of claim 11, performed by a thermostat.

18. A thermostat comprising:
a display; and
at least one sensor and a processor configured to detect a user within a vicinity of the thermostat and determine a distance of the user from the thermostat based on the detecting;
the processor further configured to determine whether a change of informational content of a display component arrangement on the display would be legible by the detected user at the determined distance, and based on the determining, change the informational content on the display.

19. The thermostat of claim 18, configured to change the informational content by adding and/or subtracting one or more items of informational content.

20. The thermostat of claim 18, configured to change the size of one or more display components of the display component arrangement for the display.
